(19) United States
(12) Patent Application Publication
(10) Pub. No.: US 2007/0004888 A1
(43) Pub. Date: Jan. 4, 2007

(54) Photoimageable composition

(76) Inventors: Ming-Hsiung Yang, Kaohsiung (TW); Hui-Kuan Mao, Kaohsiung (TW); Feng-Chih Tsai, Kaohsiung (TW)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 11/477,984

(22) Filed: Jun. 29, 2006

(30) Foreign Application Priority Data
Jul. 1, 2005 (TW) 09-4122433

(51) Int. Cl. C08F 32/08

(52) U.S. Cl. 526/280

(57) ABSTRACT

The present invention provides a negative-acting photoimageable composition comprising a polymeric binder, a photopolymerizable compound and a photoinitiator, wherein the polymeric binder contains as a polymerized unit at least one acrylate compound of the following formula: 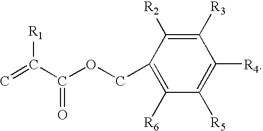 The photoimageable composition of the invention is suitable for the manufacture of printed circuit boards.

### BACKGROUND OF THE INVENTION

1. Field of the Invention

The present invention relates to a negative-acting photoimageable composition developable in an alkaline aqueous solution, which can be used as a photoresist in the processes of alkaline etching, gold plating, and electroless nickel immersion gold (ENIG) for the manufacture of printed circuit boards.

2. Description of the Prior Art

The development of photoimageable compositions, such as those disclosed in U.S. Pat. No. 5,609,991, U.S. Pat. No. 5,698,370, and U.S. Pat. No. 5,576,145, usually focuses on improving hydrophobicity by the addition of multifunctional monomers or oligomers, such as styrene or maleic anhydride copolymers, having a higher hydrophobicity, thereby enhancing the chemical resistance of the photoimageable compositions and obtaining good effects in the alkaline etching, gold plating, etc., for the manufacture of printed circuit boards. However, these prior art techniques are normally encountered disadvantages of brittleness, much shorter holding time, and easy generation of scum after development, and thus influence the yield of printed circuit boards.

To address the above problems, the inventors have found through extensive studies that the polymeric binder resulting from polymerization of a particular acrylate as the essential polymerized unit can enhance the chemical resistance of the resultant photoimageable composition, decrease the impact of the above-mentioned undesired side effects, and greatly improve the yield.

### SUMMARY OF THE INVENTION

The object of the invention is to provide a negative-acting photoimageable composition, which can be used as a photoresist in the manufacture of printed circuit boards.

The photoimageable composition of the invention comprises:
A) a polymeric binder;
B) a photopolymerizable compound; and
C) a photoinitiator,
which is characterized in that the polymeric binder of component A) contains as a polymerized unit at least one monomer having the structure of formula (1): 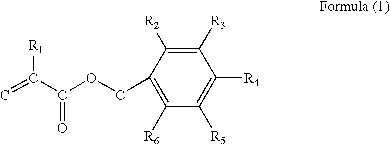
wherein, R₁ is H or methyl; and
R₂, R₃, R₄ and R₅ independently represent H, a halogen, or a substituted or unsubstituted C₁-C₁₀ alkyl.

### DETAILED DESCRIPTION OF THE INVENTION

The percentages regarding the compositions used herein are all percentages by weight, unless indicated otherwise.

To achieve the development in an alkaline aqueous solution, the component (A) of the present composition, a polymeric binder, should have sufficient acid functionality and have an acid value of at least 70 KOH mg/g, preferably 100 KOH mg/g, and more preferably more than 130 KOH mg/g and up to 250 KOH mg/g. The acid functionality is typically carboxylic acid functionality, but may also include, for example, sulfonic acid functionality and/or phosphoric acid functionality.

In the composition of the invention, the amount of component (A), the polymeric binder, is 30-80 wt %, preferably 45-75 wt % based on the total weight of the composition, and has weight average molecular weights ranging from 20,000 to 200,000, preferably from 35,000 to 120,000.

Therefore, the polymeric binder of the invention has polymerized units derived from an acid functional monomer and a non-acid functional monomer as the polymerized units. Without particular limitation, suitable acid functional monomers can be those known to persons having ordinary skill in the art, including, for example, but not being limited to, acrylic acid, methacrylic acid, maleic acid, fumaric acid, citric acid, 2-acrylamido-2-methylpropanesulfonic acid, 2-hydroxyethylacryloylphosphate, 2-hydroxypropylacryloylphosphate, and 2-hydroxy-α-acryloylphosphate. According to an embodiment of the invention, preferred acid functional monomers are acrylic acid and methacrylic acid. The polymeric binder of the invention may contain one or more acid functional monomers.

According to the present invention, the non-acid functional monomer copolymerized with the acid functional monomer comprises at least one monomer having the structure of formula (1): 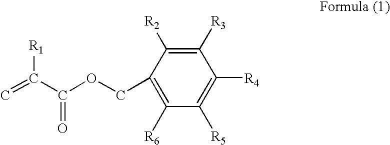
wherein, R₁ is H or methyl; and R₂, R₃, R₄ and R₅ are independently represent H, a halogen (i.e., fluorine, chlorine or bromine), or a substituted or unsubstituted C₁-C₁₀ alkyl.

According to one embodiment of the invention, the monomer having the structure of formula (1) is benzyl (meth)acrylate.

The etching resistance of a photoimageable composition depends on the Double Bond Equivalents (DBE), the greater the number of which, the better the etching resistance could be obtained. The DBE of a benzene ring is 4, which may provide an excellent etching resistance. By including a benzene ring in the structure of formula(1), the chemical resistance of the compound of formula (1) can be enhanced, and therefore the alkali-resistant ability can be improved when the development occurs in an alkaline aqueous solution. Therefore, the adhesion after the development is improved and, as a result, a good alkaline etching resistance is obtained.

The amount of the monomers having the structure of formula (1) is at least 5 wt %, preferably 5 to 35 wt %, on the basis of 100 wt % of the polymeric binder solids.

Suitable non-acid functional monomers polymerizable with the acid functional monomers include acrylates, such as methyl acrylate, methyl methacrylate, hydroxyethyl acrylate, hydroxyethyl methacrylate, ethyl acrylate, ethyl methacrylate, n-butyl acrylate, n-butyl methacrylate, t-butyl acrylate, t-butyl methacrylate, n-hexyl acrylate, n-hexyl methacrylate, octyl acrylate, octyl methacrylate, 2-ethoxyethyl acrylate, 2-ethoxyethyl methacrylate, 2-ethylhexyl acrylate, 1,5-pentanediol diacrylate, N,N-diethylaminoethyl acrylate, ethylene glycol diacrylate, 1,3-propanediol diacrylate, decanediol acrylate, decanediol dimethacrylate, 1,4-cyclohexanediol diacrylate, 2,2-dimethylolpropane diacrylate, glycerol diacrylate, tripropanediol diacrylate, glycerol triacrylate, 2,2-di(p-hydroxyphenyl)-propane dimethacrylate, triethylene glycol dimethacrylate, polyoxypropyltrimethylol propane triacrylate, ethylene glycol dimethacrylate, butylene glycol dimethacrylate, 1,3-propanediol dimethacrylate, butylene glycol dimethacrylate, 1,3-propanediol dimethacrylate, 1,2,4-butanetriol trimethacrylate, 2,2,4-trimethyl-1,3-pentanediol dimethacrylate, pentaerythritol trimethacrylate, 1-phenylethylene-1,2-dimethacrylate, pentaerythritol tetramethacrylate, trimethylolpropane trimethacrylate, 1,5-pentanediol dimethacrylate, and 1,4-benzenediol dimethacrylate; substituted or unsubstituted styrenes, such as 2-methyl styrene and vinyl toluene; and vinyl esters, such as vinyl acrylate and vinyl methacrylate. According to the embodiment of the invention, preferred non-acid functional monomers are methyl acrylate, methyl methacrylate, hydroxyethyl acrylate, hydroxyethyl methacrylate, ethyl acrylate, ethyl methacrylate, n-butyl acrylate, n-butyl methacrylate, t-butyl acrylate, t-butyl methacrylate, n-hexyl acrylate, n-hexyl methacrylate, octyl acrylate, and octyl methacrylate.

The photopolymerizable compound of the component (B) of the invention is generally a monomer or short-chain oligomer with an ethylenically unsaturated functional group, particularly α,β-ethylenically unsaturated functional group, including monofunctional, difunctional, or multifunctional groups. The component (B) suitable for the invention includes, but is not limited to, the acid functional monomers and non-acid functional monomers described above as useful for producing the polymeric binder, of which the non-acid functional monomers are preferred. The polymerizable monomers with di- or multifunctional groups may include, but are not limited to, triethylene glycol dimethacrylate, polyoxypropyltrimethylol propane triacrylate, ethylene glycol dimethacrylate, butylene glycol dimethacrylate, 1,3-propanediol dimethacrylate, 1,2,4-butanetriol trimethacrylate, 2,2,4-trimethyl-1,3-pentanediol dimethacrylate, pentaerythritol trimethacrylate, 1-phenylethylene-1,2-dimethacrylate, pentaerythritol tetramethacrylate, trimethylolpropane trimethacrylate, 1,5-pentaneol dimethacrylate, diallyl fumarate, styrene, 1,4-benzenediol dimethacrylate, 1,4-diisopropenyl benzene, 1,3,5-triisopropenyl benzene, ethoxy modified trimethylolpropane triacrylate, trimethylolpropane triacrylate, trimethylolpropane trimethacrylate and standard bisphenol-A-epoxy diacrylate.

Suitable oligomers include urethane acrylate oligomers, aliphatic urethane oligomers, and epoxy acrylate oligomers. These photopolymerizable compounds may be used in the resin composition of the invention alone or in the form of a mixture of two or more of these compounds. The amount of the photopolymerizable compound is generally in the range of 5 to 50 wt %, preferably in the range of 10 to 40 wt %, based on the total weight of the composition.

The component (C) of the present composition is a photoinitiator, which can provide free radicals upon exposure to light, and initiate polymerization through transmission of the free radicals. The species of photoinitiators are well known to persons having ordinary skill in the art. The photoinitiator suitable for the invention includes, for example, but is not limited to, n-phenyl glycine, 9-phenylacridine, benzoins, benzyldimethylketal, 2,4,5-triarylimidazole dimers (e.g., 2-(o-chlorophenyl)-4,5-diphenylimidazole dimer, 2-(o-chlorophenyl)-4,5-di(m-methoxy phenyl)imidazole dimer, 2-(o-chlorophenyl)-4,5-diphenylimidazole dimer, 2-(o-methoxy phenyl)-4,5-diphenylimidazole dimer, 2-(p-methoxy phenyl)-4,5-diphenylimidazole dimer, 2,4-di(p-methoxy phenyl)-5-phenylimidazole dimer, 2-(2,4-dimethoxy phenyl)-4,5-diphenylimidazole dimer, 2-(p-methylmercapto phenyl)-4,5-diphenylimidazole dimer). Furthermore, suitable 9-phenylacridine homologs, for example, those disclosed in U.S. Pat. No. 5,217,845, the disclosures of which are incorporated herein by reference, are also useful as a photoinitiator for the invention.

Specifically, the amount of the photoinitiator is 1.5 to 20 wt %, preferably 2 to 15 wt %.

The composition of the invention may optionally comprise an additive, component (D), well known to persons having ordinary skill in the art, including, for example, but not being limited to, dyes, stabilizers, couplers, flexibilizing agents, fillers, or a combination thereof.

The photoimageable composition of the invention can be used as a photoresist in the manufacture of printed circuit boards. For example, a photoimageable composition layer s formed from a liquid composition or transferred from a dry film is placed on the copper surface of a copper-clad board, and covered with a photomask. The photoimageable composition layer is exposed to actinic radiation, which will polymerize the monomers in the exposed area to form a cross-linked structure resistant to a developer. Moreover, the non-radiated area is developed with a diluted alkaline aqueous solution, for example, 1% aqueous sodium carbonate solution. Since the alkaline aqueous solution can promote the formation of salts with the carboxyl groups contained in the polymeric binder, the binder may become soluble and removable. After the development, the uncovered copper foil is etched and removed with an alkaline etchant, such as a mixture solution of copper-amine complex salt and aqueous ammonia, so as to form a printed circuit. Finally, the remaining photoresist layer is removed by a stripper, such as sodium hydroxide.

The present invention will be further illustrated in the examples below, which are not intended to limit the scope of the invention in any way.

### EXAMPLES

Synthesis of Polymer A-1

224 g methacrylic acid, 288 g methyl methacrylate, 104 g butyl acrylate, 120 g benzyl acrylate, and 64 g butyl methacrylate were placed in a four-neck round bottom flask, with 575 g 2-butanone and 175 g isopropanol as the solvent, stirred, and heated to reflux. A mixture of 100 g 2-butanone as a solvent and 3 g 2,2′-azobisisobutyro nitrile as an initiator was added dropwise for 1 hour. The reaction was refluxed for 0.5 hours. 50 g 2-butanone and 1 g 2,2′- azobisisobutyro nitrile were added and refluxed for 2 hours. 150 g 2-butanone and 4 g 2,2′-azobisisobutyro nitrile were then added, and refluxed for 6 hours. The reaction was cooled to afford the polymeric binder A-1, with a viscosity (25° C.) of 9800 and an average molecular weight of about 82000.

Synthesis of Polymer A-2

224 g methacrylic acid, 304 g methyl methacrylate, 136 g butyl acrylate, 120 g benzyl methacrylate, and 88 g 2-ethylhexyl acrylate were put into a four-neck round bottom flask, with 575 g 2-butanone and 175 g isopropanol as the solvent, stirred, and heated to reflux. A mixture of 100 g 2-butanone as a solvent and 3 g 2,2′-azobisisobutyro nitrile as an initiator was added dropwise for 1 hour. The reaction was refluxed for 0.5 hours. 50 g 2-butanone, 1 g 2,2′-azobisisobutyro nitrile and 48 g styrene were added and refluxed for 2 hours. 150 g 2-butanone and 4 g 2,2′-azobisisobutyro nitrile were then added, and refluxed for 6 hours. The reaction was cooled to afford the polymeric binder A-2, with a viscosity (at 25° C.) of 11500 and an average molecular weight of about 60000.

Synthesis of Polymer A-3

224 g methacrylic acid, 288 g methyl methacrylate, 104 g butyl acrylate and 64 g butyl methacrylate were put into a four-neck round bottom flask, with 575 g 2-butanone and 175 g isopropanol as the solvent, stirred, and heated to reflux. A mixture of 100 g 2-butanone, 3 g 2,2′-azobisisobutyro nitrile and 120 g styrene was then added dropwise over 1 hour, and refluxed for 0.5 hours. 50 g 2-butanone and 1 g 2,2′-azobisisobutyro nitrile were added and refluxed for 2 hours. 150 g 2-butanone and 4 g 2,2′-azobisisobutyro nitrile were then added, and refluxed for 6 hours. Thereafter, the reaction was cooled to afford the polymeric binder A-3, with a viscosity (at 25° C.) of 11000 and an average molecular weight of about 80000.

Synthesis of Polymer A-4

224 g methacrylic acid, 304 g methyl methacrylate, 136 g butyl acrylate and 88 g 2-ethylhexyl acrylate were placed into a four-neck round bottom flask, with 575 g 2-butanone and 175 g isopropanol as the solvent, stirred, and heated to reflux. A mixture of 100 g 2-butanone as a solvent and 3 g 2,2′-azobisisobutyro nitrile as an initiator and 48 g styrene was added dropwise over 1 hour, and refluxed for 0.5 hours. 50 g 2-butanone and 1 g 2,2′-azo-bis-isobutyronitrile were added and refluxed for 2 hours. 150 g 2-butanone and 4 g 2,2′-azobisisobutyro nitrile were then added and refluxed for 6 hours. Thereafter, the reaction was cooled to afford the polymeric binder A-4, with a viscosity (at 25° C.) of 10000 and an average molecular weight of about 70000.

Synthesis of Polymer A-5

224 g methacrylic acid, 368 g methyl methacrylate, 104 g butyl acrylate, 40 g benzyl acrylate and 64 g butyl methacrylate were placed into a four-neck round bottom flask, stirred and heated to reflux. A mixture of 100 g 2-butanone as a solvent and 3 g 2,2′-azobisisobutyro nitrile as an initiator were added dropwise over 1 hour, and refluxed for 0.5 hours. 50 g 2-butanone and 1 g 2,2′-azobisisobutyro nitrile were added and refluxed for 2 hours. 150 g 2-butanone and 4 g 2,2′-azobisisobutyro nitrile were then added and refluxed for 6 hours. Thereafter, the reaction was cooled to afford the polymeric binder A-5, with a viscosity (at 25° C.) of 8000 and an average molecular weight of about 45000.

Synthesis of Polymer A-6

224 g methacrylic acid, 206 g methyl methacrylate, 104 g butyl acrylate, 202 g benzyl acrylate and 64 g butyl methacrylate were placed into a four-neck round bottom flask, with 575 g 2-butanone and 175 g isopropanol as the solvent, stirred, and heated to reflux. A mixture of 100 g 2-butanone as a solvent and 3 g 2,2′-azobisisobutyronitrile as an initiator were added dropwise over 1 hour, and refluxed for 0.5 hours. 50 g 2-butanone and 1 g 2,2′-azobisisobutyro nitrile were added and refluxed for 2 hours. 150 g 2-butanone and 4 g 2,2′-azobisisobutyro nitrile were then added and refluxed for 6 hours. Thereafter, the reaction was cooled to afford the polymeric binder A-6, with a viscosity (at 25□) of 7000 and an average molecular weight of about 100000.

Synthesis of Polymer A-7

224 g methacrylic acid, 388 g methyl methacrylate, 104 g butyl acrylate, 20 g benzyl acrylate and 64 g butyl methacrylate were placed into a four-neck round bottom flask, with 575 g 2-butanone and 175 g isopropanol as the solvent, stirred, and heated to reflux. A mixture of 100 g 2-butanone as a solvent and 3 g 2,2′-azobisisobutyro nitrile as an initiator was added dropwise over 1 hour, and refluxed for 0.5 hours. 50 g 2-butanone and 1 g 2,2′-azobisisobutyro nitrile were added and refluxed for 2 hours. 150 g 2-butanone and 4 g 2,2′-azobisisobutyro nitrile were then added and refluxed for 6 hours. Thereafter, the reaction was cooled to afford the polymeric binder A-7, with a viscosity (at 25° C.) of 5500 and an average molecular weight of about 65000.

TABLE 1

| | A-1 | | A-2 | | A-3 | | A-4 | | A-5 | | A-6 | | A-7 | |
|---|---|---|---|---|---|---|---|---|---|---|---|---|---|---|
| methacrylic acid | 224 g | 27.7% | 224 g | 24.1% | 224 g | 27.7% | 224 g | 27.7% | 224 g | 27.7% | 224 g | 27.7% | 224 g | 27.7% |
| Methyl methacrylate | 288 g | 35.6% | 304 g | 32.8% | 288 g | 35.6% | 304 g | 37.6% | 368 g | 45.5% | 206 g | 25.5% | 388 g | 48.0% |
| butyl acrylate | 104 g | 12.9% | 136 g | 14.7% | 104 g | 12.9% | 136 g | 16.8% | 104 g | 12.9% | 104 g | 12.9% | 104 g | 12.9% |
| benzyl acrylate | 120 g | 14.9% | 120 g | 12.9% | — | — | — | — | 40 g | 5.0% | 202 g | 25.0% | 20 g | 2.5% |
| butyl methacrylate | 64 g | 7.9% | — | — | 64 g | 7.9% | — | — | 64 g | 7.9% | 64 g | 7.9% | 64 g | 7.9% |
| 2-ethylhexyl acrylate | — | — | 88 g | 9.5% | — | — | 88 g | 10.9% | — | — | — | — | — | — |
| Styrene | — | — | 48 g | 5.2% | 120 g | 14.9% | 48 g | 5.9% | — | — | — | — | — | — |
| 2,2′-Azobisisobutyronitrile | 8 g | 1.0% | 8 g | 0.9% | 8 g | 1.0% | 8 g | 1.0% | 8 g | 1.0% | 8 g | 1.0% | 8 g | 1.0% |
| Total | 808 g | 100% | 928 g | 100% | 808 g | 100% | 808 g | 100% | 808 g | 100% | 808 g | 100% | 808 g | 100% |

photoimageable compositions of the invention were obtained by blending the components in the amounts as shown in table 2, and stirring the blend uniformly with an agitator, with the temperature controlled at 20˜40° C.

TABLE 2
formulations of photoimageable compositions

| Photo- | | | | | | | | | | | | | | | |
|---|---|---|---|---|---|---|---|---|---|---|---|---|---|---|---|
| imageable | | Examples | | | | | | | | Comparative Examples | | | | | |
| composition (g) | | 1 | 2 | 3 | 4 | 5 | 6 | 7 | 8 | 1 | 2 | 3 | 4 | 5 | 6 |
| (a) | A-1 | 60 g | — | 60 g | — | — | — | — | — | — | — | — | — | — | — |
| poly- | | (100% | | (100% | | | | | | | | | | | |
| meric | | solids) | | solids) | | | | | | | | | | | |
| binder | A-2 | — | 60 g | — | 60 g | — | — | — | — | — | — | — | — | — | — |
| | | | (100% | | (100% | | | | | | | | | | |
| | | | solids) | | solids) | | | | | | | | | | |
| | A-3 | — | — | — | — | — | — | — | — | 60 g | — | 60 g | — | 60 g | — |
| | | | | | | | | | | (100% | | (100% | | 100% | |
| | | | | | | | | | | solids) | | solids) | | solids) | |
| | A-4 | — | — | — | — | — | — | — | — | — | 60 g | — | 60 g | — | 60 g |
| | | | | | | | | | | | (100% | | (100% | | (100% |
| | | | | | | | | | | | solids) | | solids) | | solids) |
| | A-5 | — | — | — | — | 60 g | — | — | — | — | — | — | — | — | — |
| | | | | | | (100% | | | | | | | | | |
| | | | | | | solids) | | | | | | | | | |
| | A-6 | — | — | — | — | — | 60 g | — | — | — | — | — | — | — | — |
| | | | | | | | (100% | | | | | | | | |
| | | | | | | | solids) | | | | | | | | |
| | A-7 | — | — | — | — | — | — | 60 g | 60 g | — | — | — | — | — | — |
| | | | | | | | | (100% | (100% | | | | | | |
| | | | | | | | | solids) | solids) | | | | | | |
| (b) | B1 | 20 | 20 | — | — | 20 | 20 | 20 | — | 20 | 20 | — | — | — | — |
| photo- | B2 | 15.6 | 15.6 | — | — | 15.6 | 15.6 | 15.6 | — | 15.6 | 15.6 | — | — | — | — |
| poly- | B3 | — | — | 35.6 | — | — | — | — | 35.6 | — | — | 35.6 | 35.6 | — | — |
| mer- | B4 | — | — | — | 35.6 | — | — | — | — | — | — | — | — | 35.6 | 35.6 |
| izable | B5 | 10 | 10 | — | — | 10 | 10 | 10 | — | 10 | 10 | — | — | — | — |
| com- | | | | | | | | | | | | | | | |
| pound | | | | | | | | | | | | | | | |
| (c) | C1 | 0.1 | 0.1 | 0.1 | 0.1 | 0.1 | 0.1 | 0.1 | 0.1 | 0.1 | 0.1 | 0.1 | 0.1 | 0.1 | 0.1 |
| photo- | C2 | 3.6 | 3.6 | 3.6 | 3.6 | 3.6 | 3.6 | 3.6 | 3.6 | 3.6 | 3.6 | 3.6 | 3.6 | 3.6 | 3.6 |
| initia- | | | | | | | | | | | | | | | |
| tor | | | | | | | | | | | | | | | |
| (d) | D1 | 0.65 | 0.65 | 0.65 | 0.65 | 0.65 | 0.65 | 0.65 | 0.65 | 0.65 | 0.65 | 0.65 | 0.65 | 0.65 | 0.65 |
| addi- | D2 | 0.05 | 0.05 | 0.05 | 0.05 | 0.05 | 0.05 | 0.05 | 0.05 | 0.05 | 0.05 | 0.05 | 0.05 | 0.05 | 0.05 |
| tive | | | | | | | | | | | | | | | |

Note:
B1: ethoxy modified trimethylolpropane triacrylate (PHOTOMER ® 4155, Cognis)
B2: aliphatic urethane oligomer
B3: trimethylolpropane triacrylate (ETERMER ® 231, ETERNAL CHEMICAL)
B4: trimethylolpropane trimethacrylate (ETERMER ® 331, ETERNAL CHEMICAL)
B5: standard bisphenol-A-epoxy diacrylate (ETERCURE ® 621A-80, ETERNAL)
C1: n-phenyl glycine (NPG, Hampford)
C2: imidazole dimer (BCIM, Black Gold)
D1: coupler: colorless crystal violet
D2: peacock green dye

Characterization Test:

(1) A formulated varnish formulation, after being mixed uniformly, was coated to form a coating with a thickness of 38 microns.

(2) The copper surface of a copper-clad board was pre-treated with a chemical microetching process, and the extent of the microetching was 40˜60 microinches.

(3) Pressed film: The hot roller temperature was 110±5° C.; the pressure was 3 kgw/cm²; the speed was 1.5 m/min.

(4) Exposure: The process was carried out using a Stouffer 21 at photoresist step 8 (copper step 9), after 50% development points have been developed. The line widths of the test negatives for the adhesion test were 20, 25, 30, 35, 40, 45, 50, 60, 70, 80, 90, and 100 microns.

(5) Development: 1% aqueous Na₂CO₃ solution was used; the temperature was 28±0.3° C.; the development point was 50% BP.

(6) Alkaline etching test: flask test; pH=9.5; temperature=50° C.

A pre-cut sample sheet was immersed into an etching solution, i.e. the alkaline etching solution for etching copper, which was adjusted by aqueous ammonia to a pH of 9.5, for 2 minutes, and then taken out immediately, rinsed with a large amount of water, and dried. The sample sheet was detected by microscopy for the thinnest photoresist circuit remaining on the copper surface.

(7) Gold plating test: pH=6.0; temperature=60° C.; the concentration of gold, [Au⁺]=2 g/L; the current density: about 15 ASF; time: 6 min; gold plating solution (NT-1000, provided by Auromex Co., Ltd.).

(8) Electroless nickel immersion gold test:
(a) Electroless nickel plating: temperature: 85° C.; time: 60 minutes Electroless nickel plating bath solution (NIMUDEM NPR-4, provided by Uyemura Co., Ltd)

(b) Immersion Gold: temperature: 85° C.; time: 15 minutes Immersion gold plating bath solution (AURICAL TTT-24, provided by Uyemura Co., Ltd)

TABLE 3
test results of physical properties

| | Examples | | | | | | | | Comparative example | | | | | |
|---|---|---|---|---|---|---|---|---|---|---|---|---|---|---|
| | 1 | 2 | 3 | 4 | 5 | 6 | 7 | 8 | 1 | 2 | 3 | 4 | 5 | 6 |
| Thin | 25 | 30 | 20 | 20 | 20 | 20 | 30 | 30 | 45 | 45 | 50 | 45 | 45 | 45 |
| line | mi- | mi- | mi- | mi- | microns | microns | microns | microns | microns | microns | microns | microns | microns | microns |
| adhesion | crons | crons | crons | crons | | | | | | | | | | |
| (× 2BT) | | | | | | | | | | | | | | |
| Thin line | 60 | 70 | 60 | 60 | 60 | 60 | 100 | 90 | >100 | >100 | >100 | >100 | >100 | >100 |
| adhesion of | mi- | mi- | mi- | mi- | microns | microns | microns | microns | microns | microns | microns | microns | microns | microns |
| alkaline | crons | crons | crons | crons | | | | | | | | | | |
| etching | | | | | | | | | | | | | | |
| Gold | PASS | PASS | PASS | PASS | PASS | PASS | stripped | stripped | stripped | stripped | stripped | stripped | stripped | stripped |
| plating | | | | | | | | | | | | | | |
| Electroless | PASS | PASS | PASS | PASS | PASS | PASS | stripped | stripped | stripped | stripped | stripped | stripped | stripped | stripped |
| nickel | | | | | | | | | | | | | | |
| plating | | | | | | | | | | | | | | |
| immersion | | | | | | | | | | | | | | |
| gold | | | | | | | | | | | | | | |

*PASS: unstripped

As evidenced from the test results, the compositions of Examples 1 to 6, wherein the polymerized units of the polymeric binder component comprise benzyl (meth)acrylate, have alkaline etching resistance, gold plating resistance, electroless plating nickel immersion gold resistance, and obtain a good resolution when developed in an alkaline aqueous solution due to their good alkaline resistance. On the contrary, the compositions of Comparative Examples 1 and 2, in which the polymerized units of the polymeric binder contain no benzyl (meth)acrylate, show poor physical properties, for example, poor thin line adhesion and poor developing resolution, as evidenced by the test results. Therefore, it is found from the test results on physical properties in TABLE 3 that when the polymerized units of the polymeric binder comprise benzyl (meth)acrylate, the resultant compositions possess gold plating resistance and electroless plating nickel immersion gold resistance, and may impart a good etching resistance to the photoimageable compositions of the invention because of the presence of a benzene ring.

What is claimed is:

1. A photoimageable composition, comprising, based on the total weight of the photoimageable composition:
(A) 30-80 wt % of a polymeric binder;
(B) 5-50 wt % of a photopolymerizable compound; and
(C) 1.5-20 wt % of a photoinitiator,
which is characterized in that the polymeric binder of component (A) contains as a polymerized unit at least one monomer of the structure of formula (1): 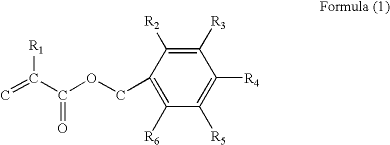
wherein, R₁ is H or methyl; and
R₂, R₃, R₄ and R₅ independently represent H, a halogen, or a substituted or unsubstituted C₁˜C₁₀ alkyl.

2. The composition according to claim 1, wherein the amount of the monomer of formula (1) is at least 5 wt %, based on the total weight of the polymeric binder.

3. The composition according to claim 1, wherein the monomer of formula (1) is benzyl (meth)acrylate.

4. The composition according to claim 1, wherein the photopolymerizable compound is an α,β-ethylenically unsaturated compound.

5. The composition according to claim 1, wherein the weight average molecular weights of component (A) range from 20,000 to 200,000.

6. The composition according to claim 5, wherein the weight average molecular weights of component (A) range from 35,000 to 120,000.
